(19) United States
(12) Patent Application Publication
(10) Pub. No.: US 2016/0298663 A1
(43) Pub. Date: Oct. 13, 2016

(54) ARRANGEMENT WITH A FLOW RECTIFIER

(71) Applicant: Carl Freudenberg KG, Weinheim (DE)

(72) Inventor: Ulrich Stahl, Laudenbach (DE)

(21) Appl. No.: 15/095,194

(22) Filed: Apr. 11, 2016

(30) Foreign Application Priority Data
Apr. 13, 2015 (EP) 15 163 346.8

(51) Int. Cl. F15D 1/02; F24F 13/28; F02M 35/02; F02M 35/024; B01D 53/04; F02M 35/10

(52) U.S. Cl. CPC F15D 1/025; B01D 53/0446; F02M 35/10314; F02M 35/0218; F02M 35/02441; F24F 13/28; B01D 2253/102; B01D 2253/3425; B01D 2259/4508; B01D 2259/4566

(57) ABSTRACT

An arrangement having a line and a flow rectifier, whereby the flow rectifier is installed in the line in order to impart a homogenized flow profile to a flowing gas after it has passed through the flow rectifier on an outflow side inside the line, whereby, with an eye towards the objective of putting forward an arrangement which has a structure that is compact and comprises few parts and which, on the one hand, allows a flowing gas to be homogenized in terms of its flow profile and, on the other hand, allows components of a gas to be adsorbed, is characterized in that the flow rectifier is configured as a honeycomb element which has a plurality of channels that are separated from each other by channel walls, whereby the honeycomb element is made of activated carbon, or else it contains activated carbon.

### CROSS-REFERENCE TO RELATED APPLICATIONS

Priority is claimed to European Patent Application No. 15 163 346.8, filed on Apr. 13, 2015, the entire disclosure of which is hereby incorporated by reference herein.

### FIELD

The invention relates to an arrangement with a line and a flow rectifier, and also to the use of a flow rectifier.

### BACKGROUND

It is a known procedure to arrange flow rectifiers in a line through which a gas flows, in order to homogenize a flow profile over a cross section through which the gas flows. For this reason, conventional arrangements comprise at least one line and one flow rectifier, whereby the flow rectifier is installed in the line in order to impart a homogenized flow profile to a flowing gas after it has passed through the flow rectifier on an outflow side inside the line.

Flow rectifiers according to the state of the art are often made of plastic or metal. Normally, the functions of flow rectification and adsorption are performed by two different components which are physically separated from each other. As a result, these two components require a large installation space in a line system meant for conveying air.

### SUMMARY

An aspect of the invention provides an arrangement, comprising: a line; and a flow rectifier, wherein the flow rectifier is installed in the line so as to impart a homogenized flow profile to a flowing gas after the flowing gas has passed through the flow rectifier on an outflow side inside the line, wherein the flow rectifier is configured as a honeycomb element including a plurality of channels that are separated from each other by channel walls, and wherein the honeycomb element comprises activated carbon.

### BRIEF DESCRIPTION OF THE DRAWING

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 an arrangement that has a flow rectifier.

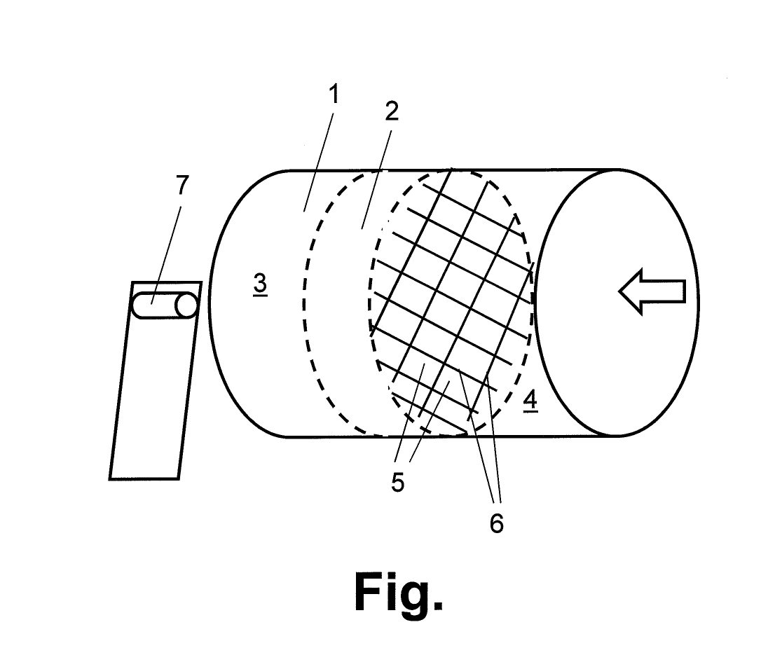

### DETAILED DESCRIPTION

Before this backdrop, an aspect of the invention puts forward an arrangement that, with a structure that is compact and comprises few parts, on the one hand, allows a flowing gas to be homogenized in terms of its flow profile and, on the other hand, allows components of a gas to be adsorbed.

According to an aspect of the invention, it has been recognized that a flow rectifier can be concurrently employed as an adsorption filter element. In this context, both functions, namely, flow rectification and adsorption, are fulfilled by one component.

According to an aspect of the invention, it has also been recognized that the flow rectifier used can be a honeycomb element which has a plurality of channels that are separated from each other by channel walls, whereby the honeycomb element is made of activated carbon, or else it contains activated carbon. The flow rectifier is structured as a honeycomb element so that the rectifying function can be variably adjusted by means of the honeycomb structure, namely, the thickness and distance of the walls. In particular, the honeycomb element is made completely of a material that consists primarily of activated carbon, or else it consists of a substrate coated with activated carbon. The activated carbon or activated carbon coating fulfills the function of adsorbing hydrocarbons.

According to an aspect of the invention, it has been concretely recognized here that two functions can be fulfilled by one compact component. According to the invention, a cost-effective solution is being put forward which meets both requirements regarding flow rectification and gas adsorption.

The honeycomb element could be made completely of activated carbon. The flow rectifier in the configuration as a honeycomb element made of activated carbon entails the advantage that its production process does not release any activated carbon particles, as a result of which the flow rectifier can be advantageously employed as an adsorption filter element.

An air-mass sensor could be installed on the outflow side. This makes it possible to implement a flow rectifier that has the task of homogenizing the air velocities in terms of their magnitude and direction in such a way that, for example, an air-mass sensor that is situated downstream from the flow rectifier in the engine-air intake tract is capable of measuring the local air velocity with very few fluctuations. Since the air velocity profile has been homogenized, the values detected by the air-mass sensor at a given place are relatively representative for other places downstream from the flow rectifier where there are no air-mass sensors.

Before this backdrop, the engine of a motor vehicle could be situated on the outflow side from which combustion gases diffuse back to the flow rectifier when the motor vehicle is at a standstill. A second function of the flow rectifier is to adsorb the hydrocarbons that flow back via an air-intake tract when the engine, namely, an internal combustion engine, is switched off, thereby preventing such hydrocarbons from escaping into the environment. The honeycomb element, which is made of activated carbon and which is used as a flow rectifier in an air-intake tract of the motor vehicle engine during operation of the engine, can be additionally used as an adsorption filter element for the hydrocarbons that are flowing back from the engine compartment when the engine is at a standstill. Thus, it helps to achieve compliance with the LEV III requirements that are applicable in the United States. Advantageously, the honeycomb element in this application is a flow rectifier and adsorption filter element all in one.

LEV Standard is the abbreviation for Low-Emission Vehicle Standard. This standard was introduced in the American state of California in 1996. Today, this program is valid in its third phase, which is why this document refers to LEV III.

LEV III relates to vehicles manufactured between 2015 and 2025. In the meantime, the LEV III standard has been adopted in 12 additional American states and will also be introduced in South Korea in 2017.

The LEV III standard stipulates the limit values for volatile hydrocarbons that a vehicle is allowed to emit when it is at a standstill for a certain period of time. Car manufacturers have to substantiate compliance with these limit values in order to attain certification in the American state in question.

In comparison to conventional adsorption filter elements that are employed to meet the LEV III requirements, the honeycomb element made of activated carbon has the advantage that, as a so-called full-flow adsorption filter element, it has a pressure differential that is at least 50% lower than that of a conventional full-flow adsorption filter element.

Conventional full-flow adsorption filter elements for LEV III requirements are, for instance, folded filter elements. Conventional folded filter elements for adsorption purposes are normally manufactured in the form of a laminate that binds activated carbon particles between carrier materials. These activated carbon particles can become detached in full-flow applications and can then be discharged along with the air flow.

The heat exchanger of an air-conditioning system could be installed on the outflow side of the flow rectifier. Another application of the above-mentioned flow rectifier consists of homogenizing the supply air flow of an air-conditioning system in terms of the magnitude and direction, and concurrently ridding it of hydrocarbons. Advantageously, the flow rectification and the gas adsorption inside an air-conditioning system are concurrently carried out by one component. Positioning the flow rectifier upstream from the heat exchanger inside an air-conditioning system enhances the efficiency, namely, the degree of effectiveness, of the heat exchanger since the flow rectifier ensures that the air flow reaches a greater surface area of the heat exchanger. This improves the efficiency of the heat exchanger. Conventional adsorption filter elements in air-conditioning systems are normally made in the form of folded filter elements consisting of a laminate that binds the activated carbon particles between the carrier materials. These activated carbon particles can become detached during operation and can then be discharged along with the air flow.

The FIGURE shows an arrangement comprising a line 1 and a flow rectifier 2, whereby the flow rectifier 2 is installed in the line, in order to impart a homogenized flow profile to a flowing gas after it has passed through the flow rectifier 2 on an outflow side 3 inside the line 1. Gas flows onto the flow rectifier 2 on the inflow side 4.

The flow rectifier 2 is configured as a honeycomb element which has a plurality of channels 5 that are separated from each other by channel walls 6, whereby the honeycomb element is made of activated carbon or it contains activated carbon. The honeycomb element is completely made of activated carbon.

The term “a plurality of” refers to more than two channels 5, preferably more than three, more than four, more than five, more than six, more than seven, more than eight, more than nine or more than ten channels 5.

An air-mass sensor 7 is arranged on the outflow side 3. The engine (not shown here) of a motor vehicle is arranged on the outflow side 3 from which combustion gases diffuse back to the flow rectifier 2.

The heat exchanger (not shown here) of an air-conditioning system can be arranged on the outflow side 3.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. An arrangement, comprising:
a line; and
a flow rectifier,
wherein the flow rectifier is installed in the line so as to impart a homogenized flow profile to a flowing gas after the flowing gas has passed through the flow rectifier on an outflow side inside the line,
wherein the flow rectifier is configured as a honeycomb element including a plurality of channels that are separated from each other by channel walls, and
wherein the honeycomb element comprises activated carbon.

2. The arrangement of claim 1, wherein the honeycomb element mainly comprises activated carbon.

3. The arrangement of claim 1, wherein the honeycomb element consists essentially of activated carbon.

4. The arrangement of claim 1, wherein the honeycomb element consists of activated carbon.

5. The arrangement of claim 1, further comprising:
an air-mass sensor, installed on the outflow side.

6. The arrangement of claim 1, wherein an engine of a motor vehicle is situated on the outflow side, from which one or more combustion gases diffuse back to the flow rectifier.

7. The arrangement of claim 1, further comprising:
a heat exchanger of an air-conditioning system installed on the outflow side.

8. The arrangement of claim 5, further comprising:
a heat exchanger of an air-conditioning system installed on the outflow side.

9. The arrangement of claim 2, further comprising:
an air-mass sensor installed on the outflow side.

10. The arrangement of claim 2, further comprising:
a heat exchanger of an air-conditioning system installed on the outflow side.

11. The arrangement of claim 9, further comprising:
a heat exchanger of an air-conditioning system installed on the outflow side.

12. The arrangement of claim 3, further comprising:
an air-mass sensor installed on the outflow side.

13. The arrangement of claim 3, further comprising:
a heat exchanger of an air-conditioning system installed on the outflow side.

14. The arrangement of claim 12, further comprising:
a heat exchanger of an air-conditioning system installed on the outflow side.

15. A method of treating a fluid flow, the method comprising:
contacting a gas with a flow rectifier,
wherein the flow rectifier acts concurrently as an adsorption filter element.

16. The method of claim 6, wherein the flow rectifier is employed in the arrangement of claim 1.
